(19) United States
(12) Patent Application Publication
(10) Pub. No.: US 2008/0174567 A1
(43) Pub. Date: Jul. 24, 2008

(54) METHOD FOR ACTIVATING AND CONTROLLING SCROLLING ON A TOUCHPAD

(76) Inventors: Richard D. Woolley, Orem, UT (US); Don T. Saxby, Salt Lake City, UT (US)

Correspondence Address: MORRISS OBRYANT COMPAGNI, P.C., 734 EAST 200 SOUTH, SALT LAKE CITY, UT, 84102, US

(21) Appl. No.: 11/960,551

(22) Filed: Dec. 19, 2007

Related U.S. Application Data
(60) Provisional application No. 60/870,718, filed on Dec. 19, 2006.

(51) Int. Cl. G06F 3/041

(52) U.S. Cl. 345/173

(57) ABSTRACT

A method of activating and using a scrolling function on a touchpad, wherein the touchpad must be capable of simultaneously detecting two fingers on the touchpad surface in order to first implement a scrolling activation function which is separate from a subsequent scrolling use function.

### CROSS REFERENCE TO RELATED APPLICATIONS

This document claims priority to and incorporates by reference all of the subject matter included in the provisional patent application docket number 3805.CIRQ.PR, having Ser. No. 60/870,718 and filed on Dec. 19, 2006.

### BACKGROUND OF THE INVENTION

1. Field of the Invention

This invention relates generally to touchpads. More specifically, the present invention relates to using a touchpad to control scrolling functions, including different methods of activating the scrolling function and then performing scrolling once the function has been activated.

2. Description of Related Art

As more devices utilize touchpads to simplify data manipulation, the use of a scrolling function is becoming more important. Furthermore, the importance of scrolling functions is not limited to desktop applications. As portable electronic appliances become more ubiquitous, the need to efficiently control them is also becoming increasingly important. The wide array of portable electronic appliances include MP3 players, portable video players, digital cameras and camcorders, mobile telephones, and many different portable entertainment devices. But even desktop devices such as desktop computers can take advantage of scrolling methods that are quick and easy to activate and then to use.

One of the main problems that many portable electronic appliances have is that their very size limits the number of ways in which communicating with the appliances is possible. One reason may be the very limited amount of space that is available. For example, mobile telephones that require a telephone number keypad are now replacing many personal digital assistants (PDAs). Typically, PDAs require a keyboard for data entry. The inventors of the present invention were involved in the discovery and development of a touchpad that is disposed underneath a telephone keypad. Placing the keypad under the telephone keymat made the best possible use of the limited space available for data entry.

Other developers and users of portable electronic appliances have seen the benefits that come from using a circular touchpad. The very nature of a circular touchpad enables continuous motion in a two different directions. However, a circular touchpad typically provides less functionality for other touchpad functions, such as cursor manipulation. Thus, it would be an advantage to provide improved scrolling functions on the typical rectangular touchpad shape.

Consider a personal digital assistant (PDA). A PDA often has to provide a full keyboard for the user in order to enter the characters of an alphabet. Even more difficult is the problem of having to deal with graphical interfaces. PDAs and even mobile telephones are becoming portable “computers” that do more than just store information or make telephone calls. Small portable electronic appliances now manipulate and process data, much like a notebook computer. Furthermore, graphical interfaces present some unique challenges when providing a user interface.

The difficulties described are not unique to PDAs and mobile telephones. Even less complex devices are providing more and more functionality. Consider an MP3 audio player that enables a user to list items such as songs, and then move through that list in order to select a song to play, move to a playlist, or examine different settings or features.

One feature of these portable electronic appliances that is common to all of those listed above and other appliances under development is the need to quickly and easily move or scroll through lists and make selections. It should be noted that all of the portable electronic appliances listed above have or will soon have touchpads disposed somewhere on or within them. This evolution is only natural considering the complex functions and graphical interfaces that they use. However, these portable electronic appliances presently lack a means for providing better activation and control of scrolling functions.

Thus, it would be an improvement over the prior art to provide a system and method for providing rapid and simple activation of the scrolling function. It would be a further improvement to provide control of the scrolling function in a manner that is different from typical use of the touchpad in order to perform other functions, such as cursor control.

As background regarding touchpads, it is useful to understand one embodiment of touchpad technology that is used to implement the present invention. Accordingly, a brief explanation of touchpad technology from CIRQUE® Corporation is provided.

The touchpad technology from CIRQUE® Corporation is a mutual capacitance-sensing device and an example is illustrated in FIG. 1. In this touchpad, a grid of row and column electrodes is used to define the touch-sensitive area of the touchpad. Typically, the touchpad is a rectangular grid of approximately 16 by 12 electrodes, or 8 by 6 electrodes when there are space constraints. Interlaced with these row and column electrodes is a single sense electrode. All position measurements are made through the sense electrode.

In more detail, FIG. 1 shows a capacitance sensitive touchpad 10 as taught by Cirque® Corporation includes a grid of row (12) and column (14) (or X and Y) electrodes in a touchpad electrode grid. All measurements of touchpad parameters are taken from a single sense electrode 16 also disposed on the touchpad electrode grid, and not from the X or Y electrodes 12, 14. No fixed reference point is used for measurements. A touchpad sensor circuit 20 generates signals from P,N generators 22, 24 that are sent directly to the X and Y electrodes 12, 14 in various patterns. Accordingly, there is a one-to-one correspondence between the number of electrodes on the touchpad electrode grid, and the number of drive pins on the touch sensor circuitry 20.

The touchpad 10 does not depend upon an absolute capacitive measurement to determine the location of a finger (or other capacitive object) on the touchpad surface. The touchpad 10 measures an imbalance in electrical charge to the sense line 16. When no pointing object is on the touchpad 10, the touch sensor circuitry 20 is in a balanced state, and there is no signal on the sense line 16. There may or may not be a capacitive charge on the electrodes 12, 14. In the methodology of CIRQUE® Corporation, that is irrelevant. When a pointing device creates imbalance because of capacitive coupling, a change in capacitance occurs on the plurality of electrodes 12, 14 that comprise the touchpad electrode grid. What is measured is the change in capacitance, and not the absolute capacitance value on the electrodes 12, 14. The touchpad 10 determines the change in capacitance by measuring the amount of charge that must be injected onto the sense line 16 to reestablish or regain balance on the sense line.

The touchpad 10 must make two complete measurement cycles for the X electrodes 12 and for the Y electrodes 14 (four complete measurements) in order to determine the position of a pointing object such as a finger. The steps are as follows for both the X 12 and the Y 14 electrodes:

First, a group of electrodes (say a select group of the X electrodes 12) are driven with a first signal from P, N generator 22 and a first measurement using mutual capacitance measurement device 26 is taken to determine the location of the largest signal. However, it is not possible from this one measurement to know whether the finger is on one side or the other of the closest electrode to the largest signal.

Next, shifting by one electrode to one side of the closest electrode, the group of electrodes is again driven with a signal. In other words, the electrode immediately to the one side of the group is added, while the electrode on the opposite side of the original group is no longer driven.

Third, the new group of electrodes is driven and a second measurement is taken.

Finally, using an equation that compares the magnitude of the two signals measured, the location of the finger is determined.

Accordingly, the touchpad 10 measures a change in capacitance in order to determine the location of a finger. All of this hardware and the methodology described above assume that the touch sensor circuit 20 is directly driving the electrodes 12, 14 of the touchpad 10. Thus, for a typical 12×16 electrode grid touchpad, there are a total of 28 pins (12+16=28) available from the touch sensor circuitry 20 that are used to drive the electrodes 12, 14 of the electrode grid.

The sensitivity or resolution of the CIRQUE® Corporation touchpad is much higher than the 16 by 12 grid of row and column electrodes implies. The resolution is typically on the order of 960 counts per inch, or greater. The exact resolution is determined by the sensitivity of the components, the spacing between the electrodes on the same rows and columns, and other factors that are not material to the present invention.

Although the CIRQUE® touchpad described above uses a grid of X and Y electrodes and a separate and single sense electrode, the sense electrode can also be the X or Y electrodes by using multiplexing. Either design will enable the present invention to function.

### BRIEF SUMMARY OF THE INVENTION

In a first embodiment, the present invention is a method of activating and using a scrolling function on a touchpad, wherein the touchpad must be capable of simultaneously detecting two fingers on the touchpad surface in order to first implement a scrolling activation function which is separate from a subsequent scrolling use function.

These and other objects, features, advantages and alternative aspects of the present invention will become apparent to those skilled in the art from a consideration of the following detailed description taken in combination with the accompanying drawings.

### BRIEF DESCRIPTION OF THE SEVERAL VIEWS OF THE DRAWINGS

FIG. 1 is a schematic block diagram of a prior art touch sensor circuit and an electrode grid of a capacitance sensitive touchpad.

FIG. 2 is a top elevational view of the surface of a touchpad, wherein scroll zones of various dimensions and locations are illustrated.

FIG. 3 is a top elevational view of the surface of a touchpad, and used to illustrate finger touchdown locations and movements that will cause scrolling in a desired manner.

FIG. 4 is a top elevational view of the surface of a touchpad, and used to illustrate finger touchdown locations and movements that will cause scrolling in a desired manner.

FIG. 5 is a top elevational view of the surface of a touchpad, and used to illustrate finger touchdown locations and movements that will cause scrolling in a desired manner.

FIG. 6 is a top elevational view of the surface of a touchpad, and used to illustrate finger touchdown locations and movements that will cause scrolling in a desired manner.

FIG. 7 is a top elevational view of the surface of a touchpad, and used to illustrate finger touchdown locations and movements that will cause scrolling in a desired manner.

FIG. 8 is a top elevational view of the surface of a touchpad, and used to illustrate finger touchdown locations and movements that will cause scrolling in a desired manner.

FIG. 9 is a top elevational view of two adjacent linear touchpads.

FIG. 10 is a top elevational view of the surface of a touchpad, and used to illustrate finger touchdown locations and movements that will cause scrolling in a desired manner.

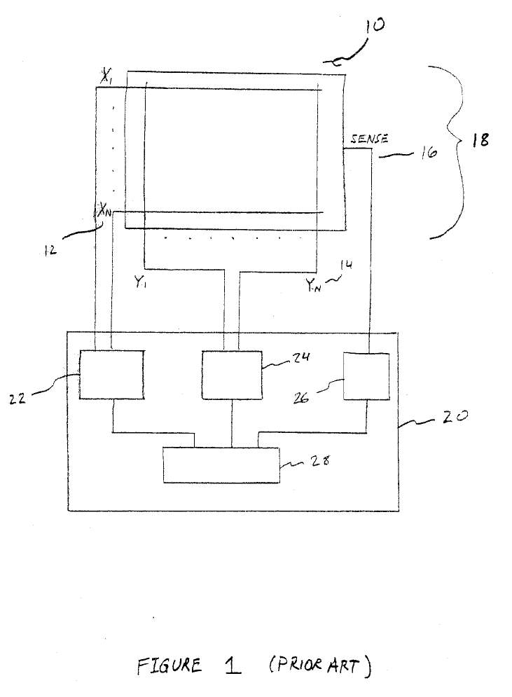

### DETAILED DESCRIPTION OF THE INVENTION

Reference will now be made to the drawings in which the various elements of the present invention will be given numerical designations and in which the invention will be discussed so as to enable one skilled in the art to make and use the invention. It is to be understood that the following description is only exemplary of the principles of the present invention, and should not be viewed as narrowing the claims which follow.

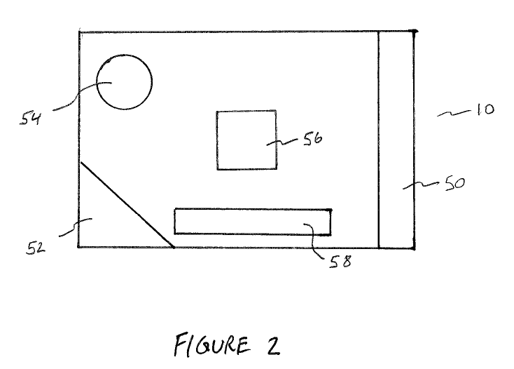

To illustrate an important concept of the present invention, a surface of a touchpad 10 is shown in FIG. 2. In this figure, various scroll zones 50, 52, 54, 56, 58 are illustrated as being located in various arbitrarily selected positions on the touchpad 10. The location of a scroll zone is not a limiting factor of the present invention, as placement can be anywhere on the touchpad surface. Another important concept is that the shape and size of the scroll zones can also be determined by the designer, and the designer is only limited to the available area of the touchpad 10. Thus, a first scroll zone 50 is shown as a vertical rectangle on the right side of the touchpad 10. This is a common shape and location for existing scroll zones.

The size, shape and location of the scroll zone or zones will typically be selected based upon various factors. These factors include the overall shape of the touchpad itself, the type of scrolling function to be performed, and the most intuitive action that might be used for a pointing object such as a finger that is performing the scrolling function.

Several other scroll zones are also shown on the touchpad 10 of FIG. 2 for illustration purposes. These scroll zones are not the only sizes, shapes and locations for scroll zones, but are only illustrative of possible examples and should not be considered to be limiting.

The first scroll zone 50 was already described. A second scroll zone 52 is shown as a triangular shape in the corner of the touchpad 10. A third scroll zone 54 is shown as a circle in the upper left-hand corner of the touchpad 10. A fourth scroll zone 56 is shown as a square in the center of the touchpad 10. A last scroll zone 58 is shown as a vertical rectangle positioned in the bottom center of the touchpad 10. These different shapes, sizes and locations thus illustrate that the dimensions and location of the scroll zone is arbitrary.

There may be many reasons why one particular scroll zone shape, size and dimension is selected over another. For example, scroll zone 50 might be used when a list or lists to be scrolled through are organized in a vertical design. Thus, the vertical rectangle shape of the scroll zone 50 provides an intuitive interface to the list.

Similarly, a list may be organized in a horizontal design. Thus, it may be better to select the horizontal rectangle shape of scroll zone 58 as a more intuitive interface to such a list. An alternative embodiment is a circular scroll zone that may or may not have a center area that does not perform any scrolling function.

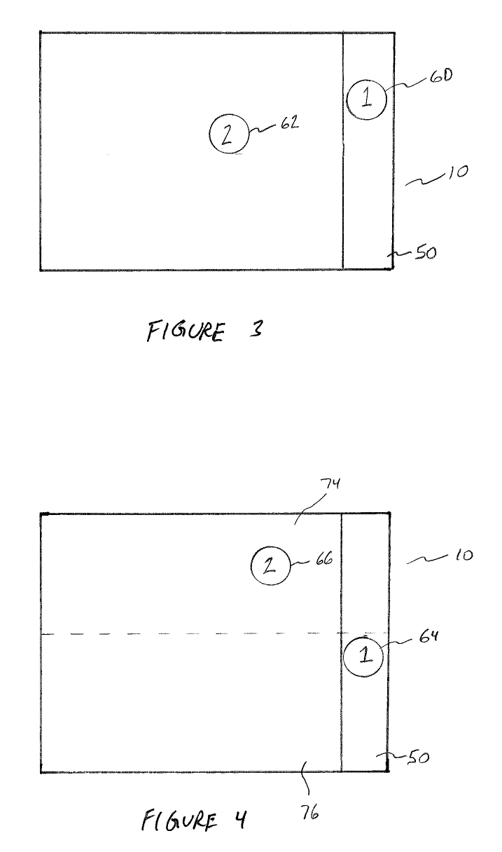

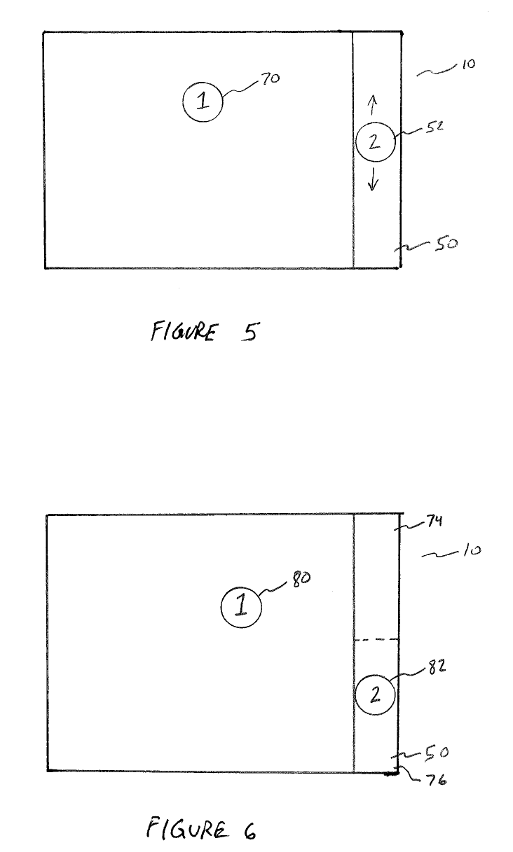

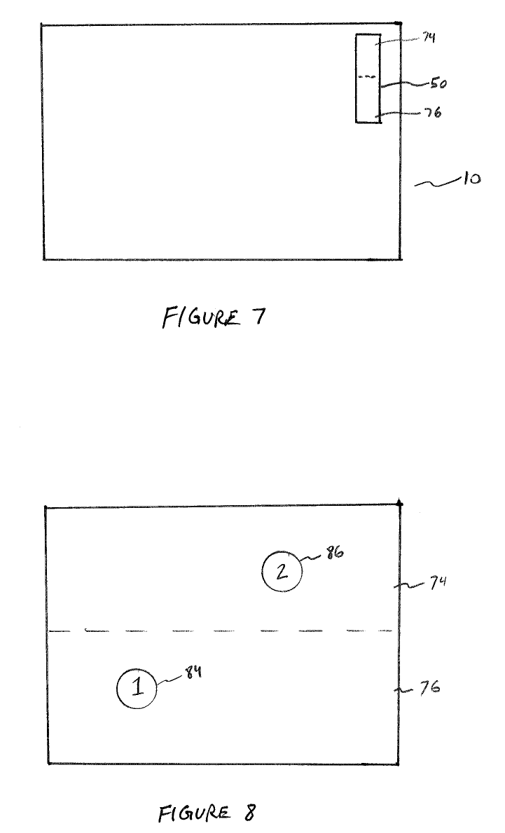

FIG. 3 is provided as a first embodiment of the present invention. In this first embodiment, scroll zone 50 is arbitrarily selected as the shape and location of the scroll zone to be used. A first location 60 is designated as a circle with the number “1” inside to thereby designate the location of touchdown of a first pointing object. In this embodiment, touchdown at location 60 within the scroll zone 50 activates the scrolling function. However, instead of having to move the pointing object up and down within the scroll zone 50, as is typically taught in the prior art, the first pointing object remains at location 60, and a second pointing object makes touchdown at any location on the touchpad 10 but outside the scroll zone 50, for example, at the location designated by the circle 62 with the number “2” disposed therein. The second pointing object is then moved, for example, in a vertical manner, up or down on the touchpad as shown by the arrows 68, to cause scrolling to occur in a list shown on a display screen that is not shown.

It should be noted that the motion that the second pointing object needs to make in order to cause scrolling to occur can be changed from a vertical motion to any desired motion. For example, the motion could be a horizontal “back and forth” motion, a diagonal motion, or even a circular motion.

It is important to realize that two pointing objects, such as fingers, may need to be simultaneously detected on the surface of the touchpad 10, and that movement of the second finger is being tracked in order to control scrolling of a list. The scroll zone 50 therefore only serves the purpose of activating the scrolling function as long as a finger stays in contact with the touchpad 10 within the scroll zone.

In an alternative embodiment, the first finger may be removed from the scroll zone 50 and the scrolling function will continue to operate until the second finger is removed from the touchpad 10. As long as the second finger remains in contact with the touchpad 10, movement of the second finger will cause scrolling to occur.

In an alternative embodiment, the second finger may be able to be lifted from the touchpad 10 and then be placed back down again to continue to perform scrolling. Deactivating the scrolling function might require a second tap in the scroll zone 50 or a timer could stop the scrolling function once the second finger is removed from the touchpad.

FIG. 4 is provided as an alternative embodiment of the present invention. In FIG. 4, a first finger makes contact at a location 64 designated as a circle with the number “1” inside to thereby designate the location of touchdown of a first pointing object. Touchdown at location 64 activates the scrolling function. Now a second pointing object makes touchdown at any location on the touchpad 10 but outside the scroll zone 50, for example, at location 66 designated as a circle with the number “2” disposed therein. However, instead of having to move the second pointing object at location 66, the second pointing object remains stationary. Scrolling takes place without having to move the second pointing object. Scrolling begins at some designated time after touchdown of the second pointing object. For example, there could be a short delay of one half a second before scrolling begins. The direction of scrolling would be determined by, for example, the location of touchdown on the touchpad 10. For example, if touchdown of the second pointing object is in the top half 74 of the touchpad 10, then scrolling is in an upwards direction. Likewise if touchdown of the second finger is in the bottom half 76 of the touchpad 10, then scrolling is in a downwards directions.

The speed of scrolling can be modified by the location of the first or the second pointing object. For example, the farther that a pointing object is away from the vertical center line of the touchpad 10, speed of scrolling would be greater. Moving the finger closer to the vertical center line would then decrease a scrolling speed. Thus, direction of scrolling could also be changed by crossing the vertical center line of the touchpad 10.

Note that in this embodiment, it is the location of the second pointing object that determines the direction of scrolling. Alternatively, it could be the touchdown location of the first pointing object relative to the top 74 and bottom 76 half of the touchpad 10 that determines the direction of scrolling.

It should also be understood that a horizontal center line could be used in place of or in conjunction with the vertical center line.

FIG. 5 illustrates another alternative embodiment. In FIG. 5, a first finger makes contact at a location 70 designated as a circle with the number “1” inside to thereby designate the location of touchdown of a first pointing object. Notice that touchdown is outside the scroll zone 50. Thus, touchdown of the first finger could be interpreted as simply indicating that some function is going to take place, such as cursor control. Thus, it requires touchdown of a second finger within the scroll zone 50 for the scrolling function to be activated. In this embodiment, the second finger must move up or down within the scroll zone 50 for scrolling to take place. The location of the second touchdown is indicated as location 72 and designated by the circle with the number “2” disposed therein.

FIG. 6 illustrates another alternative embodiment. In FIG. 6, a first finger makes contact at a location 80 designated as a circle with the number “1” inside to thereby designate the location of touchdown of a first finger. Touchdown is again outside the scroll zone 50. It requires touchdown of a second finger within the scroll zone 50 for the scrolling function to be activated. The second finger is shown as making touchdown at a location 82 designated as a circle with the number “2” inside. However, in contrast to the movement required of the second finger as shown in FIG. 5, in this embodiment, the second finger only has to make touchdown in the top half 74 or bottom half 76 of the touchpad 10 for scrolling to occur in a particular direction.

Alternatively in FIG. 7, touchdown of the second finger only has to be in the top or bottom half of a scroll zone 50, regardless of where the scroll zone 50 is located, to thereby control direction of scrolling, and regardless of where the finger is located with respect to the touchpad 10 itself. In other words, the scroll zone may be entirely within the top half 74 of the touchpad 10. Thus the top and bottom halves of the scroll zone 50 are relevant to the direction of travel.

Alternatively, as illustrated in FIG. 8, it could simply be the fact that there are two separate touchdown incidents, anywhere on the touchpad 10, for the scrolling function to be activated. Thus, there is no specific scroll zone anywhere on the touchpad 10 for activating scrolling or controlling the scrolling direction or speed. Movement of the first or second finger, arbitrarily selected to have touched down at locations 84 and 86, would be used for activation and control of the scrolling function.

Alternatively and also illustrated in FIG. 8, it is the mere detection of two pointing objects on the touchpad at the same time, and the position of the first or second finger in the top or bottom half of the touchpad 10 that will result in the scrolling action to occur. For example, as long as the first pointing object is in one half and the second pointing object is in the other half, scrolling would be activated.

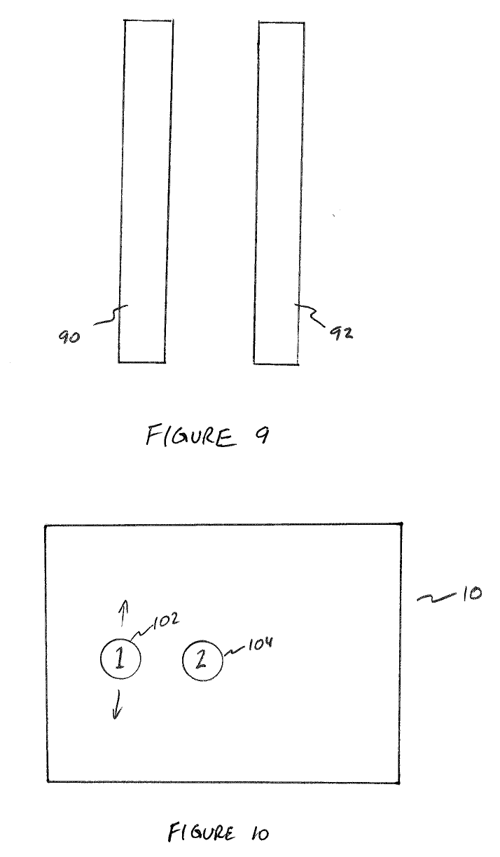

In another alternative embodiment shown in FIG. 9, two separate touchpads 90, 92 are disposed adjacent to each other. The touchpads 90, 92 may be general purpose touchpads, but are preferably linear touchpads. In this embodiment, a linear touchpad only detects location and movement of a finger or other pointing object along a lengthwise axis of the touchpad. A first linear touchpad 90 is dedicated to control coarse scrolling movements, and a second linear touchpad 92 is dedicated to control fine scrolling movements. In one embodiment, each linear touchpad 90, 92 has a dedicated function. Accordingly, it is not necessary to use two fingers for coarse and fine scrolling control. The appropriate touchpad is selected by touchdown in the scroll zone, and then scrolling is performed either by movement, or positioning a pointing object a certain distance from a vertical center line of the touchpads 90, 92.

Alternatively, the linear touchpads 90, 92 are only activated when a finger is touching both of the touchpads. Then, movement of the finger on the first linear touchpad 90 results in coarse scrolling movements, while movement of a finger on the second linear touchpad 92 results in fine scrolling movements. Assignment of fine and coarse movements to a particular touchpad is made arbitrarily, and can be switched as desired.

In another alternative embodiment shown in FIG. 10, two fingers touch the surface of a touchpad, but not simultaneously. A scrolling mode is activated when the two fingers are both detected on the touchpad 10. To perform coarse scrolling movements, one finger would be moved, and for fine scrolling movements, the other finger is moved.

For example, scrolling down in a coarse manner would be accomplished by moving the first finger at location 102 in a downward motion across the touchpad 10. Likewise, scrolling up in a coarse manner would be accomplished by moving the first finger in an upward motion across the touchpad 10. In one embodiment, it is also possible to lift the first finger to reposition it for further scrolling. The touchpad does not leave the scrolling mode until both fingers are removed from the touchpad surface.

To perform fine scrolling movements, the second finger at location designated as 104 is moved while the first finger remains stationary on the touchpad 10.

Alternatively, after touchdown of both fingers as shown in FIG. 10 at locations 102 and 104, and the touchpad has entered a scrolling mode, movement of just one finger could be used to perform coarse scrolling movements. When fine scrolling movement is desired, then both fingers would be moved together. Alternatively, both fingers might be moved for coarse scrolling control, and movement of a single finger can be used for fine scrolling control. However, it is more likely that it will necessary to lift a finger for repositioning during coarse scrolling control. Having to lift both fingers might be possible, for example, if a time-out period is provided. As long as the user returns both fingers to the touchpad before a time-out period has expired, then the scrolling control being used would then be continued without interruption.

It is to be understood that the above-described arrangements are only illustrative of the application of the principles of the present invention. Numerous modifications and alternative arrangements may be devised by those skilled in the art without departing from the spirit and scope of the present invention. The appended claims are intended to cover such modifications and arrangements.

What is claimed is:

1. A method of activating and using a scrolling function for a list that is displayed on a display screen, said method comprising the steps of:
(1) detecting touchdown of a first pointing object on a touchpad within a scroll zone to thereby activate a scrolling function;
(2) detecting a second pointing object on the touchpad and not within the scroll zone while the first pointing object is still in contact with the touchpad in the scroll zone; and
(3) dragging the second pointing object to thereby cause scrolling within a list on a display screen.

2. A method of activating and using a scrolling function for a list that is displayed on a display screen, said method comprising the steps of:
(1) detecting touchdown of a first pointing object on a touchpad within a scroll zone to thereby activate a scrolling function;
(2) detecting a second pointing object on the touchpad and not within the scroll zone while the first pointing object is still in contact with the touchpad in the scroll zone; and
(3) determining if the second pointing object is above or below a vertical center line of the touchpad; and
(4) scrolling up within a list shown on a display screen when the second pointing object is disposed above the vertical center line of the touchpad, and scrolling down within the list shown in the display screen when the second pointing object is disposed below the vertical center line of the touchpad.

3. The method as defined in claim 2 wherein the method further comprises the step of controlling a speed of scrolling, said method comprising the step of scrolling through the list as a function of the distance of the second pointing object from the vertical center line, wherein scrolling is faster when the second pointing object is farther from the vertical center line.

4. The method as defined in claim 3 wherein the method further comprises the step of controlling a direction of scrolling, said method comprising the step of scrolling through the list as a function of being above or below the vertical center line, wherein scrolling moves up when the second pointing object is above the vertical center line, and scrolling moves down when the second pointing object is below the vertical center line.

5. A method of activating and using a scrolling function for a list that is displayed on a display screen, said method comprising the steps of:
(1) detecting touchdown of a first pointing object on a touchpad outside a scroll zone;
(2) detecting touchdown of a second pointing object on the touchpad within the scroll zone while the first pointing object is still in contact with the touchpad; and
(3) dragging the second pointing object within the scroll zone to thereby cause scrolling within a list on a display screen.

6. A method of activating and using a scrolling function for a list that is displayed on a display screen, said method comprising the steps of:
(1) detecting touchdown of a first pointing object on a touchpad outside a scroll zone;
(2) detecting touchdown of a second pointing object on the touchpad and within the scroll zone while the first pointing object is still in contact with the touchpad; and
(3) determining if the second pointing object is above or below a vertical center line of the touchpad; and
(4) scrolling up within a list shown on a display screen when the second pointing object is disposed above the vertical center line of the touchpad, and scrolling down within the list shown in the display screen when the second pointing object is disposed below the vertical center line of the touchpad.

7. The method as defined in claim 6 wherein the method further comprises the step of controlling a speed of scrolling, said method comprising the step of scrolling through the list as a function of the distance of the second pointing object from the vertical center line, wherein scrolling is faster when the second pointing object is farther from the vertical center line.

8. The method as defined in claim 7 wherein the method further comprises the step of controlling a direction of scrolling, said method comprising the step of scrolling through the list as a function of being above or below the vertical center line, wherein scrolling moves up when the second pointing object is above the vertical center line, and scrolling moves down when the second pointing object is below the vertical center line.
